(19) United States
(12) Patent Application Publication
(10) Pub. No.: US 2006/0277111 A1
(43) Pub. Date: Dec. 7, 2006

(54) Transaction system and method

(76) Inventor: Paul Desmond Bevis, St. Ives (AU)

Correspondence Address: GOTTLIEB RACKMAN & REISMAN PC, 270 MADISON AVENUE, 8TH FLOOR, NEW YORK, NY, 100160601, US

(21) Appl. No.: 11/147,007

(22) Filed: Jun. 7, 2005

(51) Int. Cl. G06Q 30/00

(52) U.S. Cl. 705/26

(57) ABSTRACT

A method, system, computer program and apparatus for facilitating a sales transaction in relation to goods and/or services wherein the consumer: is provided with a list of one or more online member merchants selling goods and/or services in which the consumer is interested based upon the payment type accepted by online merchants; orders goods and/or services of a selected online member merchant, receives payment information in relation to said ordered goods and/or services, and makes payment for said ordered goods and/or services at an offline member merchant. Upon receipt of payment, a confirmation message is sent to the online member merchant, who then delivers the goods and/or services to the consumer.

### FIELD OF THE INVENTION

This invention generally relates to the field of purchasing goods or services online, and in particular, to the payment for goods and/or services at a location remote from a merchant. More specifically, the invention relates to a method, system, computer instruction code, and/or apparatus for locating goods or services of interest online and providing payments to merchants.

### BACKGROUND OF THE INVENTION

One traditional purchasing model is to offer goods or services for sale at a physical store front. To make a purchase, a customer physically enters into the store, selects an item, and then makes payment. This payment may be in the form of cash, check, credit card or debit card.

Methods for placing orders and making payments have become more complex with the advent of e-commerce and mail order companies. For example, many merchants now offer their goods or services on websites that are accessible over the Internet. In such cases, a consumer may make a purchase by accessing the website, selecting an item offered at the site and then providing a credit card number. If the credit card is accepted, the consumer's credit card account is charged and the item is shipped to a receiving address. Using standard credit card processing and settlement techniques, the merchant's bank account is eventually credited with payment.

Merchants, both large and small, must, in order to achieve competitive efficiencies undertake multi-channelling, ie offer goods and services for purchase online via websites in addition to operating a physical store. Many merchants, however, do not have the IT infrastructure and/or personnel to offer secure credit card payments via a website. Also, some merchants are unable to accept credit cards or similar payment instruments for a variety of other reasons. For example, the merchant may not qualify to be serviced by a credit card processor, the merchant may not have a bank account where funds may be deposited, or may be in a country where conducting transactions by credit cards is difficult or impossible.

Also, the majority of the world's consumers, especially those in developing nations, are unlikely to ever have access to credit facilities. In this respect, in some developing countries, bank accounts are not commonly held by consumers. Even if a consumer has a credit card, the banking system and fees make it difficult for a customer in one country to directly purchase goods or services from a merchant in another country, especially if the countries in question do not have international banking treaties. Other consumers, concerned with privacy, identification fraud and/or credit card fraud avoid purchasing goods or services via websites. Online retail fraud is another major concern. In 2004, online retail fraud losses have been estimated to be as much as US$2.6 billion (or 1.8% of total online sales. This estimate was provided by Mountain View, a Calif. based corporation that provides payment and risk management solutions and represents a US$700 million increase as compared with the estimated fraud loss in 2003. It is further predicted by Clements Communications in New York that online fraud losses will reach US$3.2 billion in 2007. Whilst these estimates are alarming, there is a further concern that online fraud losses are under reported possibly by as much as 200 per cent due to retailers concerns regarding adverse publicity resulting from such reports. These limitations and concerns described above all present difficulties with respect to developing global ecommerce.

While consumers may use systems or arrangements where an account is credited with funds in advance and debited for small transactions, consumers are unlikely to commit substantial funds to a prepaid account, even if the use of a prepaid account overcomes their security and privacy concerns. Similarly, other systems that overcome the risk of interception and unauthorised use of credit cards, still require consumers to have a credit card, or at the very least a bank account.

Accordingly, it is an object of the present invention to provide a method, system, computer instruction code, and/or apparatus to allow consumers to locate an online merchant that provides goods and/or services of interest based on the type of payment arrangement accepted by the merchant and to make payment to a merchant for any goods or services ordered online whilst ameliorating one or more of the above described problems.

Any discussion of documents, devices, acts or knowledge in this specification is included to explain the context of the invention. It should not be taken as an admission that any of the material formed part of the prior art base or the common general knowledge in the relevant field of technology on or before the priority date of the claims herein.

### SUMMARY OF THE INVENTION

### METHOD OF THE INVENTION

According to one aspect, the present invention provides a method for facilitating a sales transaction in relation to goods and/or services, said method including the steps of:

providing a consumer with a list of one or more online member merchants offering goods and/or services by payment type accepted by online member merchants;

the consumer selecting goods and/or services to purchase and generating an online order for said selected goods and/or services and causing transmission of the order to an online member merchant;

providing payment information to the consumer in relation to said ordered goods and/or services;

the consumer providing payment for said ordered goods and/or services at an offline member merchant;

the offline member merchant causing transmission of a confirmation message to said selected online member merchant in relation to receipt of payment; and

said selected online member merchant providing said ordered goods and/or services to the consumer.

The online member merchant selected by the consumer may credit the consumer with loyalty reward points if the consumer is a member of a loyalty rewards program.

The term online member merchant includes any merchant who offers goods and/or services for sale and communicates same to consumers over a data communication network.

The term offline member merchant includes any merchant who has the facility to receive payments directly from a consumer. An offline member merchant may include an apparatus that is operable to receive payments in the form of cash or other valuable consideration.

### SYSTEM OF THE INVENTION

According to another aspect, the present invention provides a system for facilitating a sales transaction in relation to goods and/or services, said system including:

a computer server connected to a data communications network operable to provide a consumer with a list of one or more online member merchants offering goods and/or services by payment type accepted by online member merchants;

a communication device connected to a data communications network operable for the consumer to select goods and/or services to purchase from an online member merchant and generate an online order for the goods and/or services selected and transmit the order through the data communications network to the online member merchant;

an online order receiving means operable to receive orders and generate a notification that provides payment information to the consumer in relation to said ordered goods and/or services;

payment receiving means located at an offline merchant having a physical location which the consumer can visit and provide payment for said ordered goods and/or services, said payment receiving means recording receipt of payment; and

offline member merchant communication means for transmitting a confirmation message to said selected online member merchant to notify receipt of payment to said selected online member merchant for the provision of said ordered goods and/or services to the consumer.

### COMPUTER SOFTWARE PROGRAM CODE FOR IMPLEMENTING THE INVENTION

According to yet another aspect, the present invention provides a computer program embodied on a computer readable medium for facilitating sales transactions in relation to goods and/or services, said computer program including:

computer instruction code for listing one or more online member merchants offering selected goods and/or services to consumers by payment type accepted by online member merchants:

computer instruction code for receiving online orders from consumers of selected goods and/or services of a selected online member merchant;

computer instruction code for transmitting orders to said selected online member merchants;

computer instruction code for providing payment information to consumers in relation to said ordered goods and/or services;

computer instruction code for receiving, from offline member merchants, confirmation of payments from consumers for said ordered goods and/or services; and

computer instruction code for transmitting confirmation messages to said selected online member merchants in relation to receipt of payments.

Preferably, the computer program includes computer instruction code for establishing, maintaining and managing a merchant account and for a consumer to establish an account for the receipt of rewards points each time they use a service of this type. In the instance where a rewards scheme is implemented, the computer program preferably includes computer instruction code for crediting a customer's account with rewards points each time a purchase is made.

In a particularly preferred embodiment, the computer program includes computer instruction code to enable an established consumer rewards account to interface to nominated e-commerce micro-payment engines.

In another embodiment, the computer code includes computer instruction code for transmitting funds to an online merchant's nominated account upon receipt of same by the offline merchant.

The computer code may result in computer instructions that are implemented integrally to a computer or on a network of computers using separate software components. The code may also include components of existing software that effect functions in cooperation with dedicated code developed specifically for the present invention.

### APPARATUS OF THE INVENTION

According to yet another aspect, the present invention provides a server for facilitating a sales transaction in relation to goods and/or services, said server including:

listing means for providing a listing of one or more online member merchants offering selected goods and/or services to a consumer according to payment type accepted by online member merchants;

order receiving means for receiving an online order from the interested consumer of selected goods and/or services of a selected online member merchant;

order transmitting means for transmitting said order to said selected online member merchant;

communication means for providing payment information to the consumer in relation to said ordered goods and/or services;

payment confirmation receiving means for receiving, from an offline member merchant, confirmation of payment from the consumer for said ordered goods and/or services; and

message transmitting means for transmitting a confirmation message to said selected online member merchant in relation to receipt of payment.

It is preferred that consumers are able to conduct an online search of member merchants, and/or products and/or services based on selected criteria such as product/service category, or whether the online merchant is a participant in a rewards program. In a particularly preferred embodiment, the selection criteria may also include the location of offline member merchants such that the consumer can select goods and/or services in the knowledge that they can arrange payment at a convenient offline member merchant.

It is also preferred that funds are transmitted from the offline member merchant to the online member merchant.

Payment information provided to a consumer preferably includes some form of machine readable code to automate the process of providing funds to an offline member merchant. The machine readable code could be in the form of a transmitted code from a mobile phone, personal digital assistant or some other suitably configured electronic transmitting device. However, in a preferred embodiment, the payment information includes a machine readable code in the form of a printed barcode.

It is further preferred that a member merchant may be both an online member merchant and an offline member merchant.

### BRIEF DESCRIPTION OF THE DRAWINGS

A preferred embodiment of the present invention is now described with reference to the accompanying drawings, in which:

FIG. 1 is a schematic diagram of a system for facilitating a sales transaction according to a preferred embodiment of the invention;

FIG. 2 is a flow chart illustrating one method for merchants to be approved as member merchants;

FIG. 3 is a flow chart illustrating one method for facilitating a sales transaction according to the invention;

FIG. 4 is a flow chart illustrating one method for a merchant to register on a casual basis;

FIG. 5 is a flow chart illustrating one method for a merchant to register on a permanent basis;

FIG. 6 and 6a is a flow chart illustrating one method for facilitating a sales transaction without a loyalty rewards scheme; and

FIGS. 7 and 7a is a flow chart illustrating one method for facilitating a sales transaction with a loyalty rewards scheme.

### DETAILED DESCRIPTION

The present invention is not specific to any particular hardware or software implementation, and is at a conceptual level above specifics of implementation. It is to be understood that various other embodiments and variations of the invention may be produced without departing from the spirit or scope of the invention. The following is provided to assist in understanding the practical implementation of one embodiment of the invention.

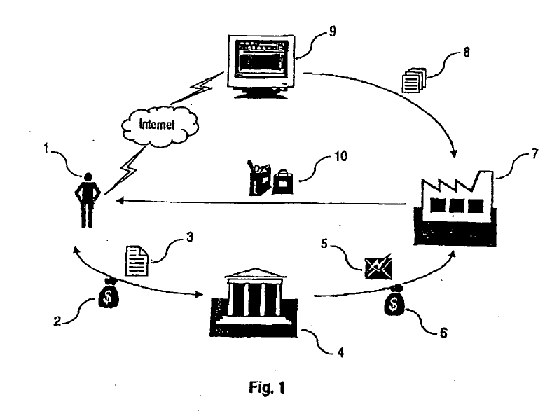

With reference to FIG. 1, the conceptual drawing illustrates the logical interactions of a sales transaction system. The system will typically include a system website 9, able to be accessed by both consumers and merchants, and a system database, which will typically store information in relation to merchants, orders, purchases, and consumers.

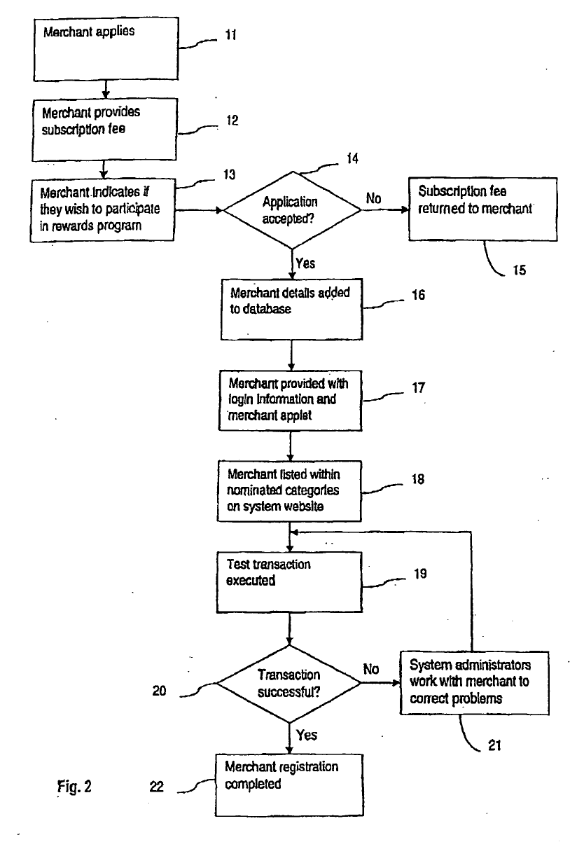

With reference to FIG. 2, the flow chart details the primary method steps that are effected in a particularly preferred embodiment of the present invention in approving a merchant as an online and/or offline member merchant 7.

The merchant accesses the system website 9 and applies, as per step 11, to be an online and/or offline member merchant. The merchant will typically be required to complete an online form including, for example, company details, bank account details, and in relation to online merchant applications, additional information such as product categories, etc will also be required. Online merchant applicants may also be required to pay a subscription fee, as per step 12, to the administrators of the sales transaction system. It will be appreciated that the application form may also take the form of traditional paper application forms which could mailed or faxed to the administrators of the system.

It will be appreciated that the sales transaction system may involve optional participation in a rewards program which will typically attract more orders for the online merchant 7 but may cost slightly more in terms of either subscription fee or per order fee.

The administrators of the sales transaction system will consider the application as per step 14. If the application is rejected, the merchant is informed of the decision and the subscription fee is returned. If the application is accepted, the merchant's details are added, as per step 16, to the system database, and the merchant is provided, as per step 17, with a merchant member number/card, login information and in relation to online member merchants 7, an applet allowing them to upload descriptions of their goods and/or services to the system website 9. The goods and/or services of the online merchant 7 will typically be categorised on the system website 9, as per step 18. In order to complete the process, the administrators of the system and the online member merchant 7 will work together to complete one or more test transactions successfully as per steps 19 to 22.

In an alternate embodiment, the system website 9 will link to each online merchant's 7 website where, when placing an order, the consumer 1 will be able to choose the system as their preferred method of payment for the order.

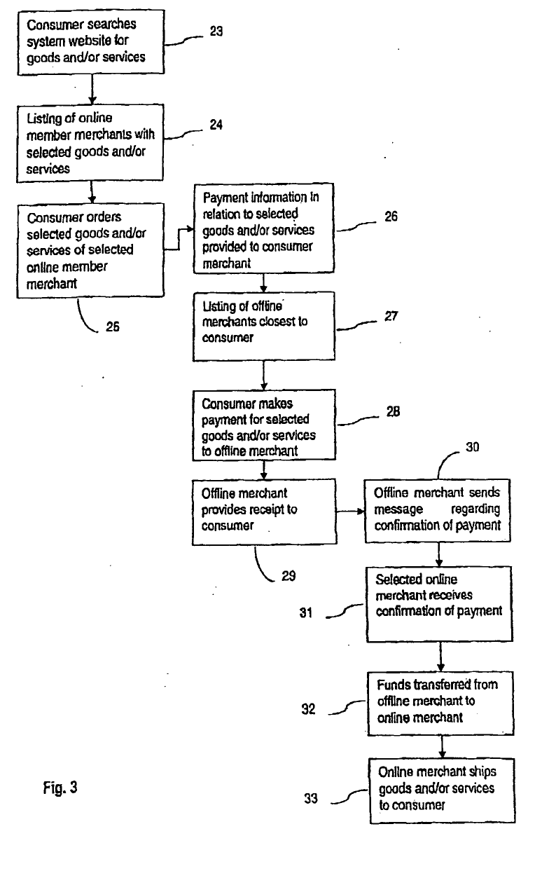

With reference to FIG. 3, the flow chart details the primary method steps that are effected in a particularly preferred embodiment of the present invention that enables a consumer to make payment to a merchant for goods and/or services ordered online.

A consumer 1 interested in purchasing certain goods and/or services navigates to the system website 9. The consumer 1 is able to search for specific goods and/or services by entering, for example, keywords, manufacturer's name and/or price ranges. Alternatively, the consumer 1 may browse listed goods and services, which may be categorised by, for example, type, manufacturer or price, for the goods and/or services they are seeking and in particular, the payment type accepted by online member merchants.

Once the consumer 1 locates the goods or services they are interested in purchasing, the system website 9 provides, as per step 24, a listing of all online merchants able to provide the selected goods or services. As per step 25, the consumer 1 is able to select an online merchant 7 and place an order for the selected goods or services.

Alternatively, the consumer 1 is able to browse or search the goods and/or services of a specific online merchant 7.

The consumer 1 enters contact and delivery details, after which the sales transaction system forwards the order 8 to the online merchant 7. Preferably, the system provides the option of storing the consumers contact and/or delivery details for use in subsequent transactions by means of a unique consumer membership identifier.

The system, as per step 26, provides to the consumer 1 details of the purchase, including information such as the total payment due, the date by which payment is due and a machine readable code in the form of an encoded barcode. Preferably, this payment information 3 is in the form of a PDF file which can be printed by the consumer 1.

To pay the online merchant 7 for the goods and/or services 10 ordered, the consumer 1 visits an offline member merchant 4 who is preferably located in close proximity to the consumer 1. Offline merchants may be physical store fronts, petrol stations, etc. A list of the closest offline member merchants can be generated by the system upon the input of, for example, the delivery address or postcode of the consumer 1. Preferably, the system displays a map of the local area in which the locations of the closest offline member merchants are highlighted.

The offline member merchant 4 scans the encoded barcode printed on the payment information and as per step 28, accepts payment 2 for the goods and/or services 10 ordered online. Preferably, the offline member merchant 4 will accept payment 2 in the forms usually accepted at physical store fronts, such as cash, direct debit or credit card. It will be appreciated that the consumer 1 will need to pay a small convenience fee such as a small predetermined amount or a small percentage of the overall cost of the goods and/or services 10 ordered.

As per step 29, the offline member merchant 4 also typically provides a receipt 3 to the consumer 1. It will be appreciated that the payment details of the online order can also be accessed by the offline member merchant 4 via the system website 7, typically after a unique order number is quoted by the consumer 1.

The offline member merchant 4, as per step 30, confirms receipt of payment, typically by logging onto the system website 7, and updating the status of the order. The offline member merchant 4 will also typically enter their unique merchant member number to indicate they are holding the funds.

Confirmation of receipt of payment will then be forwarded, as per step 31, to the online merchant 7 with whom the order was placed indicating that they are now able to ship the goods and/or provide the services 10 to the consumer 1.

In an alternate embodiment, a message 5 confirming receipt of payment from the consumer 1 may be sent directly from the offline member merchant 4 to the online merchant 7.

Usually in concurrency with the goods and/or services 10 being provided to the consumer 1 as per step 33, funds 6 equalling the payment 2 made by the consumer, typically minus 3 to 4% (which approximates the credit card fee the online merchant 7 would be charged in relation to a conventional online transaction involving payment by credit card) will be transferred from the offline merchant's 4 account to the online merchant's account. Typically, the offline member merchant 4 will keep the remaining funds as payment for their services. Alternatively, the remaining funds will be transferred to the account of the administrators of the sales transaction system.

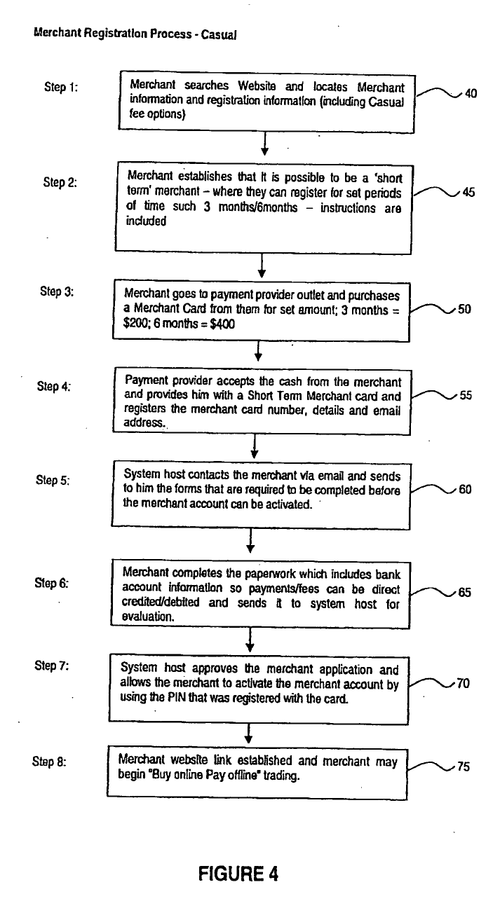

With reference to FIG. 4, a flow chart detailing a casual merchant registration process is illustrated. In this respect, at Step 1 (40) a merchant conducts a search on an internet website and locates the merchant and registration information (including casual fee options) for the Buy online Pay offline system. At Step 2 (45) the merchant locates information in relation to becoming a “short term” merchant where they can register for a limited period of time such as three or six months etc. At Step 3 (50), the merchant then proceeds to a payment provider outlet and purchases a merchant card enabling them to act as a casual merchant for the limited period of time desired. For example, in a preferred embodiment, to act as a casual merchant for three months would cost A$200.00 and for six months the cost would be A$400.00.

At Step 4 (55) the payment provider accepts cash from the merchant and provides them with a short term merchant card and registers the merchant card number, details and email address. At Step 5 (60) a system host contacts the merchant by email and sends the forms that are required to be completed before the merchant account can be activated. At Step 6 (65) the merchant completes the forms including bank account information in order for payments/fees to be direct credited/debited and upon completion of the forms the merchant transmits same to the system host for evaluation. At Step 7 (70) the system host considers the forms received from the merchant and approves the merchant application thus allowing the merchant to activate the merchant account by using a PIN that was registered with the card. At Step 8 (75) a link from the system host website to the merchant website is established and as a result, the merchant may commence trading within the “Buy online Pay offline” system. In this particular embodiment of casual registration, at the end of the time period for which registration has been effected, the merchant account,expires such that no further trading can be conducted and the website link previously established by the system host is removed.

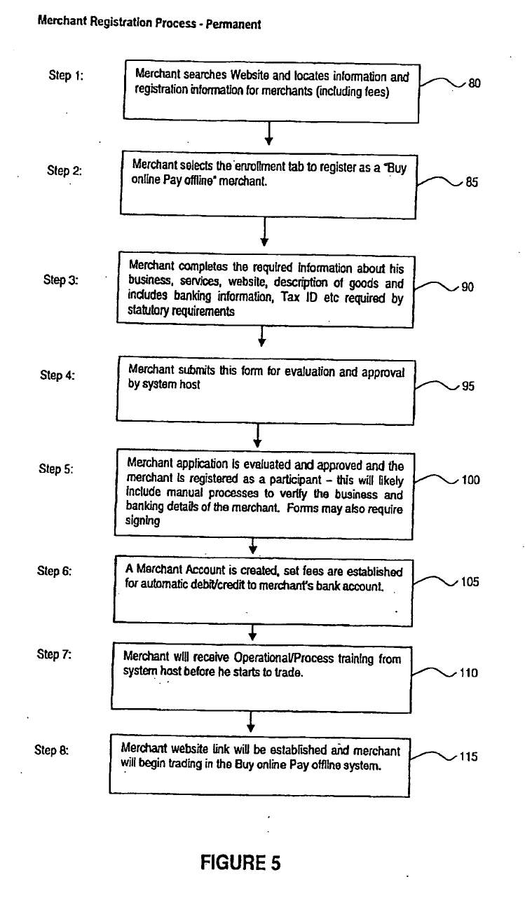

With reference to FIG. 5, a flow chart detailing the process steps involved in permanent registration of a merchant is illustrated. In this respect, at Step 1 (80) a merchant conducts a search on a website and locates merchant and registration information including fee information relating to registration of the merchant as a member of the Buy online Pay offline system. At Step 2 (85) the merchant selects the enrolment tab to register as a permanent merchant.

At Step 3 (90) the merchant completes the required information regarding their business, services, websites and description of goods and services including banking information, tax identification information and any other statutory information required for the establishment of the merchant as a participant in the Buy online Pay offline system. At Step 4 (95) the merchant submits the completed forms for evaluation and approval by the system host.

At Step 5 (100) the merchant application is received, evaluated and approved and the merchant is registered as a participant in the Buy online Pay offline system. This step would most likely include manual processes to verify business and banking details of the merchant and forms may also require execution.

At Step 6 (105) a merchant account is created and an automatic debit/credit arrangement is preferably established for the fee for the merchant to participate in the Buy online Pay offline system and for receiving payments from offline merchants. At Step 7 (110) the merchant will receive operational/process training from a system host prior to the commencement of trading.

At Step 8 (115) a website link is established to the merchant website from the system host website and thus the merchant may begin trading in the Buy online Pay offline system.

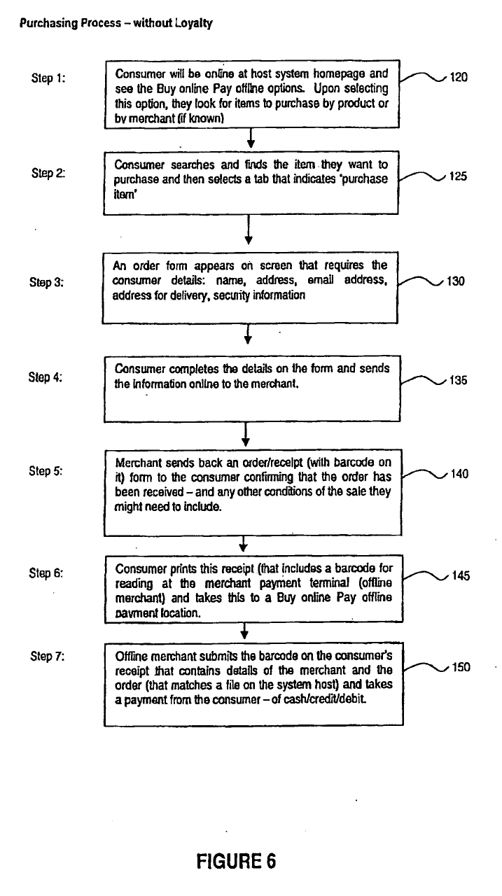

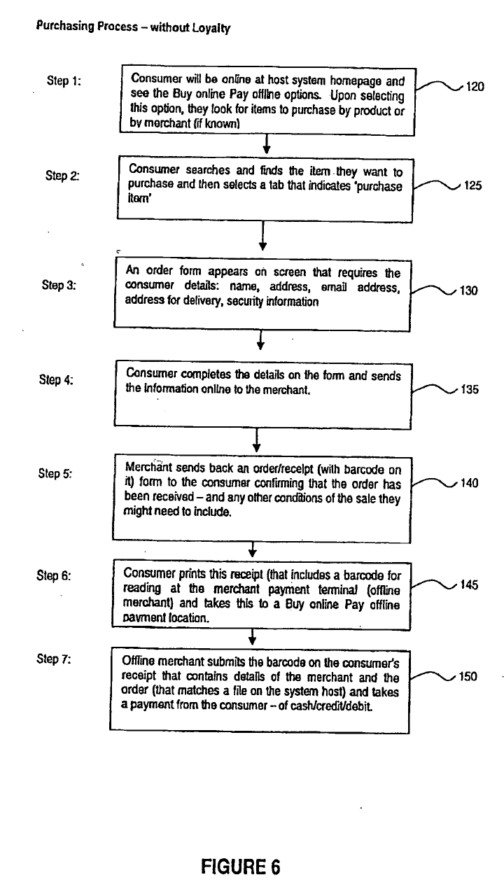

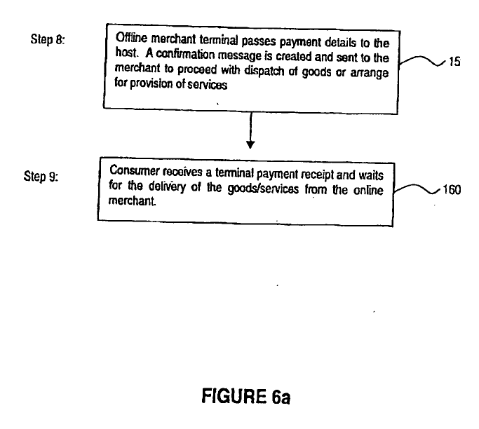

With reference to FIGS. 6 and 6a, a process flow chart detailing the process of making a purchase with the Buy online Pay offline system without any consideration for rewarding the consumer for loyalty to the system. In this respect, at Step 1 (120) the consumer can connect to the host system online and view the webpage and locate the Buy online Pay offline option for purchasing goods and/or services. Upon selecting this option, the consumer is transferred to the Buy online Pay offline system home page and may commence a search for goods and/or services of interest by conducting the search according to a range of additional selection categories. At Step 2 (125) the consumer searches and locates an item that they wish to purchase and then selects a tab or selection indicia that indicates to the system that the consumer intends to purchase the item.

At Step 3 (130) an order form is presented to the consumer onscreen requiring the consumer to enter their details including name, address, email address, delivery address and security information. At Step 4 (135) the consumer enters the details in the order form and transmits the form to the relevant merchant.

At Step 5 (140) the merchant receives the consumer order form and transmits back to the consumer an order/receipt preferably with a barcode confirming that the order has been received and any other conditions that the consumer should know before they proceed to arrange to make payment for the selected item. At Step 6 (145) the consumer may print the receipt received from the merchant (including the barcode) and then proceeds to a Buy online Pay offline payment location in a preferred embodiment of the invention, there are numerous payment locations to provide maximum opportunity for a consumer to provide an offline payment. To provide a pervasive presence of offline merchants, it is expected that arrangements would be established with well established retail franchises that provide 24 hour per day, seven day a week retail services thus providing maximum opportunity for consumers to locate an offline merchant in near proximity.

At Step 7 (150) the offline merchant submits the barcode on the consumer's receipt containing details of the merchant and the order to a barcode reader connected to a data communications network and operable to match the barcode with a file containing relevant details located on the system host. The offline merchant then receives payment from the consumer for the goods and/or services identified in the file on the system host linked to the barcode on the consumer's receipt. At Step 8 (155) the offline merchant terminal then passes payment details to the system host and a confirmation message is generated and transmitted to the online merchant to enable the online merchant to proceed with dispatch of the goods or arrange for the provision of services. At Step 9 (160) the consumer receives a payment receipt from the offline merchant terminal and waits for delivery of the goods/services from the online merchant.

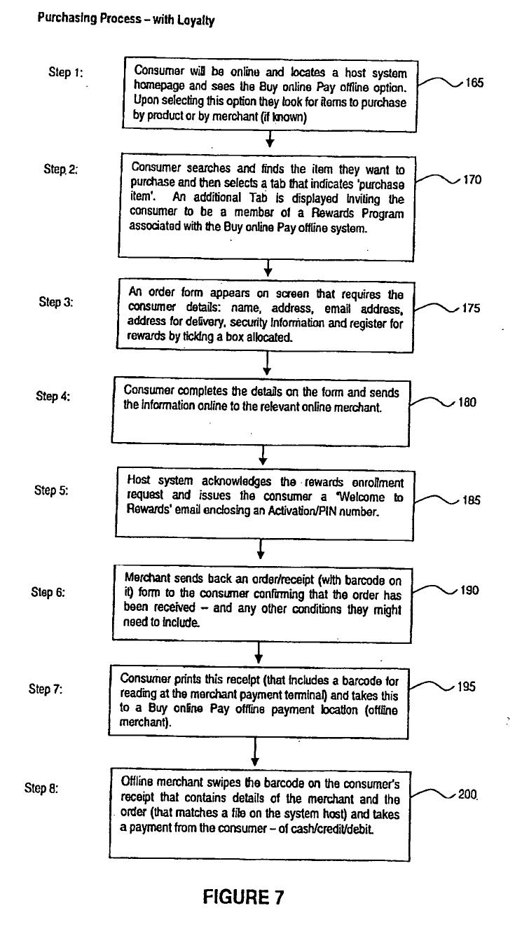

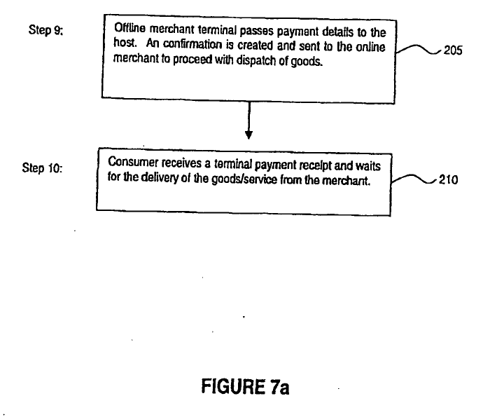

With reference to FIGS. 7 and 7a, a purchasing process in accordance with the Buy online Pay offline system is detailed with the provision of loyalty/reward points to a consumer as a result of making a purchase by use of this system. At Step 1 (165) a consumer conducts a search online and locates a host system home page and recognises the Buy online Pay offline option. Upon selecting this option, the consumer may commence their search for items of interest to purchase based upon various additional search and selection criteria. At Step 2 (170) the consumer conducts a search for an item of interest that they wish to purchase and then selects a tab or other selection indicia that enables the consumer to indicate their intention to purchase the item. At this stage, an additional selection indicia may be presented to the consumer requesting whether the consumer wishes to be a member of a rewards program associated with the use of the Buy online Pay offline system.

At Step 3 (175) an order form is presented to the consumer on the screen of their communication device that requires the consumer to enter their details including their name, address, email address, delivery address, security information and a positive indication that the consumer wishes to register rewards allocated by the rewards program.

At Step 4 (180) the consumer completes the details on the form and transmits same to the relevant online merchant from whom they wish to purchase the selected item. At Step 5 (185) the host system acknowledges the consumers enrolment in the rewards program and generates and transmits an email enclosing an activation PIN number. At Step 6 (190) the merchant receives the consumer order form and transmits back to the consumer an order/receipt (preferably with a barcode) confirming that the order has been received and any other conditions that the consumer might need to be aware of before arranging payment for the selected item. In a preferred embodiment, the details of the consumer order are stored on a database connected to the host system and includes a reference number for the file that is associated with the barcode provided to the consumer for their particular purchase request.

At Step 7 (195) the consumer prints the receipt from the merchant and proceeds with same to a Buy online Pay offline payment location (ie offline merchant). At Step 8 (200) the offline merchant submits the barcode on the consumer's receipt to a barcode reader connected to a merchant payment terminal. Upon identifying the barcode on the consumer's receipt, a message is transmitted to the system host with the code identifying the consumer's order. The cost of the order is passed back to the offline merchant to detail the funds required to settle the order and upon receipt of same from the consumer, the offline merchant provides details of the settlement to the system host.

At step 9 (205) the offline merchant terminal passes the payment details to the online member merchant which is accepted by the online merchant as an authorisation to proceed to dispatch the ordered goods and/or services to the consumer. In this respect, the online member merchant will receive settlement for the goods/services provided to the consumer in accordance with a pre-arranged settlement procedure between online and offline member merchants.

At step 10 (210) the consumer is provided with a payment receipt which acts as proof of payment and awaits delivery of the goods/services from the online merchant.

1. A method for facilitating a sales transaction in relation to goods and/or services, said method including the steps of:
providing a consumer with a list of one or more online member merchants offering goods and/or services by payment type accepted by online member merchants;
the consumer selecting goods and/or services to purchase and generating an online order for said selected goods and/or services and causing transmission of the order to an online member merchant;
providing payment information to the consumer in relation to said ordered goods and/or services;
the consumer providing payment for said ordered goods and/or services at an offline member merchant;
the offline member merchant causing transmission of a confirmation message to said selected online member merchant in relation to receipt of payment; and
said selected online member merchant providing said ordered goods and/or services to the consumer.

2. A method according to claim 1, said method further including the following step:
allowing the consumer to conduct an online search of member merchants and/or goods and/or services based on selected criteria.

3. A method according to claim 1, said method further including the following step:
providing physical location information to the consumer in relation to offline member merchants.

4. A method according to claim 1, said method further including the following step:
transmitting funds from the offline member merchant to said selected online member merchant.

5. A method according claim 1 wherein the payment information includes a machine readable code.

6. A method according to claim 5 wherein the machine readable code is a printed barcode.

7. A method according to claim 1 wherein a member merchant is both an online member merchant and an offline member merchant.

8. A method according to claim 1 wherein online member merchants subscribe to register as an available online merchant for consumers and remain available for the period of their subscription.

9. A method according to claim 1 wherein online member merchants and/or consumers may register to participate in a loyalty reward scheme such that purchases from an online member that participates in the reward scheme accrues reward points for the consumer.

10. A method according to claim 9 wherein the criteria for selecting an online member merchant includes whether the online member merchant is a participant in a loyalty reward scheme.

11. A system for facilitating a sales transaction in relation to goods and/or services, said system including:
a computer server connected to a data communications network operable to provide a consumer with a list of one or more online member merchants offering goods and/or services by payment type accepted by online member merchants;
a communication device connected to the data communications network and operable for the consumer to select goods and/or services to purchase from an online member merchant and generate an online order for the goods and/or services selected and transmitting the order through the data communications network to the online member merchant;
an online order receiving means operable to receive orders and generate a notification that provides payment information to the consumer in relation to said ordered goods and/or services;
payment receiving means located at an offline merchant having a physical location which the consumer can visit and provide payment for said ordered goods and/or services, said payment receiving means recording receipt of payment; and
offline member merchant communication means for transmitting a confirmation message to said selected online member merchant to notify receipt of payment to said selected online member merchant for the provision of said ordered goods and/or services to the consumer.

12. A system according to claim 11, said system further including:
notification means for providing physical location information to the consumer in relation to offline member merchants.

13. A system according to claim 11, said system further including:
transmission means for transmitting funds from the offline member merchant to said selected online member merchant.

14. A system according to claim 11 wherein the payment information includes a machine readable code.

15. A system according to claim 14 wherein the machine readable code is a printed barcode.

16. A system according to claim 11 wherein a member merchant is both an online member merchant and an offline member merchant.

17. A system according to claim 11, said system further including:
searching means for consumers to conduct an online search for goods/services of interest including one or more of the following search criteria:
the goods and/or services of interest;
the status of online merchants with respect to participation in a loyalty reward scheme; or
the location of offline member merchants through which payments are processed.

18. A computer program embodied on a computer readable medium forfacilitating sales transactions in relation to goods and/or services, said computer program including:
computer instruction code for listing one or more online member merchants offering selected goods and/or services to consumers by payment type accepted by online member merchants;
computer instruction code for receiving online orders from consumers of selected goods and/or services at a selected online member merchant;
computer instruction code for transmitting orders to said selected online member merchants;
computer instruction code for providing payment information to consumers in relation to said ordered goods and/or services;
computer instruction code for receiving, from offline member merchants, confirmation of payments from consumers (or said ordered goods and/or services; and
computer instruction code for transmitting confirmation messages to said selected online member merchants in relation to receipt of payments.

19. A computer program according to claim 18, said computer program further including:
computer instruction code for consumers to conduct an online search of member merchants, and/or goods and/or services based on selected criteria.

20. A computer program according to claim 18, said computer program (further including:
computer instruction code for providing location information to the consumer in relation to offline member merchants.

21. A computer program according to claim 18, said computer program further including:
computer instruction code for initiating transmission of funds from the offline member merchant to said selected online member merchant

22. A computer program according to claim 18 wherein the payment information includes a machine readable code.

23. A computer program according to claim 22 wherein the machine readable code is a printed barcode.

24. A computer program according to claim 18 where, in the instance of a consumer purchase from an online member merchant and both the consumer and the online member merchant are participants in a loyalty reward scheme, the computer program includes computer instruction code for crediting a consumer's account with loyalty rewards in proportion to the purchase from the online member merchant.

25. A server for facilitating a sales transaction in relation to goods and/or services, said server including:
listing means for providing a listing of one or more online member merchants offering selected goods and/or services to a consumer according to payment type accepted by online member merchants;
order receiving means for receiving an online order from the interested consumer of selected goods and/or services of a selected online member merchant;
order transmitting means for transmitting said order to said selected online member merchant;
communication means for providing payment information to the consumer in relation to said ordered goods and/or services;
payment confirmation receiving means for receiving from an offline member merchant, confirmation of payment from the consumer for said ordered goods and/or services; and
message transmitting means for transmitting a confirmation message to said selected online member merchant in relation to receipt of payment.

26. A server according to claim 25, said server further including:
searching means for consumers to conduct an online search for goods/services of interest including one or more of the following search criteria:
the goods and/or services of interest;
the status of online merchants with respect to participation in a loyalty. reward scheme; or
the location of offline member merchants through which payments are processed.

27. A server according to claim 25, said server further including:
communication means for providing location information to the consumer in relation to offline member merchants.

28. A server according to claim 25, said server further including:
communication means for initiating transmission of funds from the offline member merchant to said selected online member merchant.

29. A server according to claim 25 wherein the payment information includes a machine readable code.

30. A server according to claim 29 wherein the machine readable code is a printed barcode.

31. (canceled)
